(19) United States
(12) Patent Application Publication
(10) Pub. No.: US 2005/0129815 A1
(43) Pub. Date: Jun. 16, 2005

(54) Process for destroying bacteria or controlling bacteria growth in a substrate

(76) Inventor: Stephen D. Kelleher, Ipswich, MA (US)

Correspondence Address: Paul J. Cook, 115 Pine Street, Manchester, MA, 01944, US

(21) Appl. No.: 11/043,625

(22) Filed: Jan. 26, 2005

Related U.S. Application Data
(63) Continuation-in-part of application No. 10/655,604, filed on Sep. 5, 2003, now abandoned.

(51) Int. Cl. A23C 3/00

(52) U.S. Cl. 426/323

(57) ABSTRACT

Bacteria growth is controlled or destroyed in a food substrate by applying to the substrate an aqueous acidic protein solution isolated from animal muscle tissue and/or a peptide derived from the protein.

### REFERENCE TO RELATED APPLICATION

This application is a continuation-in-part of application Ser. No. 10/655,604, filed Sep. 5, 2003.

### BACKGROUND OF THE INVENTION

This invention relates to a process for controlling bacterial growth or destroying bacteria in or on a solid, gas or liquid substrate, such as bacteria in a food. More particularly, this invention relates to a process for preserving a food against bacterial growth in the food by adding to the food an aqueous acidic protein solution, a concentrated aqueous acidic protein solution and/or aqueous acidic peptide solution isolated from animal muscle tissue.

A major problem in the food industry, particularly with meat, poultry and eggs is the growth of pathogenic bacteria in the food which causes infections that result in intestinal disorders such as nausea, vomiting, abdominal cramps, diarrhea and even death. Six of the most common bacteria food contaminants are Salmonella, Listeria, E. Coli, that produce verocytotoxin (VT), e.g., E. coli 1057, Campylobacter, Staphylococcos aureus and Clostridium perfringens.

When food is contaminated with a small number of bacteria, it can be seriously contaminated within twenty-four hours due to the ability of the bacteria to divide and multiply quickly. Salmonella is found in unpasteurized milk, eggs, raw egg products, meat and poultry. Clostridium perfringens is commonly found in meat and poultry. Listeria is found in poultry and meat and is resistant to common food preservation agents such as heat, salt, nitrite and acids. Campylobacter is one of the more commonly identified cause of food contamination and is commonly found in poultry, red meat and unpasteruized milk. Although most strains of the E. coli are harmless, those that produce VT can cause serious illness.

Accordingly, it would be desirable to provide a process whereby bacteria in a substrate such as food would be either destroyed or growth therein could be controlled to a safe level thereby to permit safe consumption of the food by humans.

### SUMMARY OF THE INVENTION

In accordance with this invention, an acidic composition comprising an “aqueous acidic protein solution” isolated from animal muscle tissue or “concentrated aqueous acidic protein solution” isolated from animal muscle tissue and/or an “aqueous acidic peptide solution” derived from the protein isolated from animal muscle tissue is added to a substrate such as a food in order to destroy bacteria in the substrate. The food can be uncooked, cooked or partially cooked and is coated, admixed and/or injected with the aqueous acidic protein solution or concentrated aqueous acidic protein solution and/or aqueous acidic peptide solution. The aqueous acidic protein solution derived from animal muscle tissue comprises a mixture of myofibrillar proteins and sarcoplasmic proteins from a composition obtained by mixing comminuted animal muscle tissue with a physiologically acceptable acid and disclosed in U.S. Pat. Nos. 6,005,073; 6,288,216; and/or 6,451,975 and/or U.S. Patent application Ser. No. 10/161,171, filed Jun. 4, 2002 all of which are incorporated herein by reference in their entirety. The compositions useful in the present invention also can be obtained from the aqueous acidic protein solutions described in U.S. Pat. Nos. 6,005,073; 6,288,216; 6,451,975 and application Ser. No. 10/161,171 by subjecting the aqueous acidic protein solution to filtration, including microporous filtration (a.k.a. microfiltration), ultrafiltration, reverse osmosis filtration or diafiltration to retain a concentrated aqueous acidic protein solution containing myosin protein and actin protein in the retentate to a protein composition above about 0.5%, preferably above 4.0% by weight protein based on the weight of the solution and recovering the retentate. The retentate solution can be utilized as the aqueous concentrated acidic protein solution of this invention to destroy bacteria in food. Also, in accordance with this invention, an aqueous acidic peptide solution derived from the protein isolated from animal muscle tissue useful in the present invention.

By the phrase “aqueous acidic protein solution” as used herein is meant a aqueous solution of myofibrillar proteins and sarcoplasmic proteins obtained by dissolving animal muscle tissue in a physiologically acceptable aqueous acid and having a pH of about 3.5 or less and preferably between about 1.5 and about 2.5 but not so low as to adversely affect the protein functionality. By the phrase, “aqueous acidic peptide solution” is meant an acidic solution of peptide derived from the protein isolated from animal muscle tissue. The protein is converted to a peptide with an enzyme that divides the protein molecules into smaller amino acid chains.

In accordance with this invention for destroying bacteria in a food, the aqueous acidic protein solution, concentrated aqueous acidic protein solution and/or aqueous acidic peptide solution of this invention can be injected into the food or it can be applied to the surface of the food and/or it can be mixed with the food. The pH of the added solution is about 3.5 or less, preferably between about 1.5 and about 2.5. It has been found that by utilizing the process of this invention, bacteria in or on food can be completely destroyed even over extended periods of a week or longer.

### DESCRIPTION OF SPECIFIC EMBODIMENTS

In accordance with this invention, a substrate such as a food to be treated to control or destroy bacteria is coated, admixed and/or injected with the aqueous acidic protein solution isolated from animal muscle tissue and/or the aqueous acidic peptide solution derived from the protein isolated from animal muscle tissue. The aqueous acidic protein solution comprises a mixture of myofibrillar proteins and sarcoplasmic proteins derived from animal muscle tissue and is obtained by the processes disclosed in U.S. Pat. Nos. 6,005,073, 6,288,216, 6,451,975, and Ser. No. 10/161,171, filed Jun. 4, 2002 in the form of a first acidic solution which can be utilized in the process of this invention. The acidic solution is formed by mixing a physiologically acceptable acid with comminuted animal muscle tissue. Alternatively, the first acidic solution can be filtered with a microporous, ultrafiltration or diafiltration membrane solution to recover a protein rich retentate. The retentate comprises a concentrated aqueous acidic protein solution and is obtained under filtration conditions to recover a protein composition that includes myosin protein and actin protein in the retentate while directing an aqueous acid and/or salt solution into the permeate. In diafiltration, water is added to the protein solution to be filtered in order to carry salts and/or acid through the filter into the permeate. Water addition is ceased and filtration is continued to reduce the water in the retentate.

The aqueous acidic protein solution is obtained by one of two processes. In these processes, (acid processes) animal muscle tissue is formed into small tissue particles which are then mixed with sufficient acid to form a solution of the tissue having a pH of 3.5 or less, but not such a low pH as to adversely modify the animal tissue protein, e.g., about 1.0 or less. In one of these two processes, the solution is centrifuged to form a lowest membrane lipid layer, an intermediate layer of aqueous acidic protein solution and a top layer of neutral lipids (fats and oils). The intermediate layer of aqueous acidic protein solution is then separated from the membrane lipid layer or from both the membrane lipid layer and the neutral lipid layer. In a second of these two processes, the aqueous acidic protein solution is recovered without a centrifugation step since the starting animal muscle tissue contains low concentrations of undesired lipids, oils and/or fats. In both processes, the protein mixture is free of myofibrils and sarcomeres. In both processes, the aqueous acidic protein solution can be filtered to recover a myosin-rich and actin-rich retentate which comprises the concentrated aqueous acidic protein solution useful in this invention and to direct an aqueous acid/and or salt solution or water which may or may not contain cholesterol into the permeate. The concentrated aqueous acidic protein solution contains above 0.5 wt. % protein, preferably to 4 wt. % protein based on the concentrated aqueous acidic protein solution and can be utilized with the substrate such as food to be treated to control or destroy bacteria. The use of the concentrated aqueous acidic protein solution provides the process advantages of eliminating the prior art steps of raising the pH of the initial aqueous acid protein solution followed by a protein precipitation step. In addition, the concentrated aqueous acidic protein solution has a protein to salt weight ratio greater than about 50 so that it can be pasteurized by heating while avoiding the formation of a gel. By virtue of the solution being in liquid form rather than a gel form, contact with the substrate to be treated in accordance with this invention is facilitated. The recovered concentrated aqueous acidic protein solution then can be mixed with, injected into or coated on the food to be cooked or to be preserved.

Filtration can be effected by microporous filtration, ultrafiltration, or diafiltration. Microporous filtration can be effected with a water wettable microporous membrane such as a membrane designed to retain particles having an average size between about 0.01 and 5 microns. Ultrafiltration can be effected with a water wettable membrane designed to retain particles having an average size between about 0.001 and about 0.02 microns.

Ultrafiltration is effected with a water wettable ultrafiltration membrane having a molecular weight cut-off which effects retention of myosin heavy chain protein (˜205,000 Daltons) and actin protein (˜42,000 Daltons). Representative suitable ultrafiltration membranes have a molecular weight cut-off between about 3,000 Daltons and about 100,000 Daltons, preferably between about 10,000 Daltons and about 50,000 Daltons. Ultrafiltration membranes having a molecular weight cut-off above 42,000 Daltons can be utilized to retain myosin and actin since the acidic conditions of the solution cause the protein to unfold thereby promoting their retention by the ultrafiltration membranes. Ultrafiltration can be effected by tangential flow filtration (TFF) with a single pass or with multiple passes over the ultrafilter. The retentate recovered during filtration comprises the concentrated aqueous acidic protein solution useful in this invention, which can be utilized directly. The concentrated aqueous acidic protein solution useful in this invention comprising the retentate has reduced water concentration, salt concentration and possibly reduced low molecular weight protein concentrations, as compared to the first aqueous acidic protein solution which is not filtered. The concentrated aqueous acidic protein solution contains between about 0.5 and about 25 weight percent protein, preferably between 4 and 12 weight percent, based upon the total weight of the aqueous acidic protein solution. Filtration also can be effected with diafiltration membrane which permits passage there through of water or an aqueous acid and/or salt solution while retaining proteins. Representative suitable membranes include, polyethersulfones, polyamides, polycarbonates, polyvinylchloride, polyolefins such as polyethylene or polypropylene, cellulose esters such as cellulose acetate or cellulose nitrate, regenerated cellulose, polystyrene, polyimides, polyetherimides, acrylic polymers, methacrylic polymers, copolymers thereof, blends thereof or the like.

The aqueous acidic protein solution or the concentrated aqueous acidic protein solution can be applied alone or in admixture with the aqueous acidic peptide solution to the food to be treated to control or destroy bacteria. It is preferred to utilize the concentrated aqueous acidic protein solution, by coating such as by immersion, spraying or tumbling. The concentrated aqueous acidic protein solution can be pasteurized by heating while avoiding gel formation. This promotes ease of application to a food such as by spraying, immersion or injection.

In summary, the dilute aqueous acidic protein solution or the concentrated aqueous acidic protein solution can be obtained by the following representative methods:
1. Reduce the pH of comminuted animal muscle tissue to a pH less than about 3.5 to form an acidic protein solution, centrifuge the solution to form a lipid-rich phase and an aqueous phase, recover a first aqueous acidic protein solution substantially free of membrane lipids comprising the aqueous acidic protein solution. The aqueous acidic protein solution then can be filtered to isolate the retentate comprising the concentrated aqueous acidic protein solution.
2. Increase the pH of the aqueous acidic protein solution from method 1 to about pH 5.0-5.5 to effect precipitation of the proteins and then readjust the protein back to a pH of about 4.5 or less using acid in a minimum volume to form an aqueous acidic protein solution containing between about 3.5-7% protein. These protein solutions can be filtered to recover the concentrated aqueous acidic protein solution in the retentate.
3. Reduce the pH of comminuted animal muscle tissue to form a first aqueous acidic protein solution. The aqueous acidic protein solution can be filtered to produce the concentrated aqueous acidic protein solution useful in the present invention.

The concentrated aqueous acidic solution is capable of being formed into a gel. The gel is formed by placing the protein into a chopper that is pre-chilled with ice. One part protein (powder) is mixed with 3.7 parts cold water and two (2%) percent NaCl is added to the chopper. The material is adjusted, if necessary, to pH 6.8-7.4. The material is then chopped between 2-3 minutes. The protein prior to cooking should have a moisture content in the 74-82% range. The chopped, protein paste is placed into a polymeric, e.g. polyethylene bag and all the air is removed by hand pressing. The paste is rolled to a thickness of 3 mm and placed for 25 seconds on high in a microwave oven, and then cooled. The final cooled material is tested for its ability to double-fold and rated on a 5-point scale as described by Kudo et al. (1973, Marine Fish. Rev. 32:10-15).

The protein products utilized in the present invention comprise primarily myofibrillar proteins that also contains significant amounts of sarcoplasmic proteins. The sarcoplasmic proteins in the protein product admixed with, injected into or coated on the food comprises above about 6%, preferably above about 8%, more preferably above about 12% and most preferably above about 15%, up to about 30% by weight sarcoplasmic proteins, based on the total weight of protein in the aqueous acidic protein solution or the concentrated aqueous acidic protein solution. The aqueous acidic peptide solution can be obtained by the process disclosed in copending application Ser. No. 10/367,026, filed Feb. 19, 2003, which is incorporated herein by reference. The aqueous acidic peptide solution utilized in the present invention can be produced from the aqueous acidic protein solution or concentrated aqueous acidic protein solution with one or more enzymes which convert the protein to peptides.

In addition, the protein precursor for the peptide can be provided by an alkali process as described below. In alkaline processes, animal muscle tissue is formed into small tissue particles which are then mixed with sufficient aqueous base solution to form a solution of the tissue wherein at least 75% of the animal muscle protein is solubilized, but not such a high pH as to adversely modify the animal tissue protein. In one process, the solution is centrifuged to form a lowest membrane lipid layer, an intermediate aqueous protein rich layer and a top layer of neutral lipids (fats and oils). The intermediate aqueous protein-rich layer then is separated from the membrane lipid layer or from both the membrane lipid layer and the neutral lipid layer. In a second process, no centrifugation step is effected since the starting animal muscle proteins contain low concentrations of undesired membrane lipids, oils and/or fats. In both processes, the protein mixture is free of myofibrils and sarcomeres. In both processes, the pH of the protein-rich aqueous phase can be lowered to a pH about 3.5 or below, preferably between about 2.5 and 3.5. In both processes, the protein in the aqueous acidic solution is recovered after centrifugation (when used) or by drying the aqueous acidic protein solution, such as by evaporation, spray drying or lyophilization to form a powder product having the low pH it had when it was dissolved in the aqueous acidic solution. The aqueous acidic protein solution or dry protein composition then is mixed with an enzyme that converts the protein to a peptide composition. The peptide composition then can be dried such as by evaporation, lyophilization or spray drying or it can be retained as an aqueous acidic peptide solution which can be applied directly to the meat, fish or vegetable prior to cooking it. The protein in aqueous basic solution having a pH above 8.5 and recovered after centrifugation (when used) can be mixed with an acid to reduce its pH and can be dried, such as by spray drying or lyophilization to form a powder. In one aspect of these two other processes, the pH of the basic solution can be lowered to about 5.5 to precipitate the protein. The pH of the precipitated protein then is raised to between 6.5 and 8.5 and a solid product is recovered such as by drying including spray drying, lyophilization or evaporation or which can be comminuted and converted to the peptide composition with an enzyme. The enzymes can be exoproteases and can be active to produce peptides at an acidic pH, an alkaline pH or a neutral pH. Representative suitable enzymes useful at acidic pH include Enzeco Fungal Acid Protease (Enzyme Development Corp., New York, N.Y.; Newlase A (Amano, Troy, Va.); and Milezyme 3.5 (Miles Laboratories, Elkhart, Ind.) or mixtures thereof. Representative suitable enzymes useful at alkaline pH include Alcalase 2.4 LFG (Novozyes, Denmark). Representative suitable enzymes useful at neutral pH include Neutrase 0.8 L (Novozymes, Denmark) and papain (Penta, Livingston, N.J.) or mixtures thereof. After the peptide is formed, the pH of the peptide solution is adjusted to pH 3.5 or less for use in the present invention to control or destroy bacteria. After the peptide is formed, the pH of the peptide solution is adjusted to about 3.5 or less.

The enzymes utilized in amounts of between about 0.02% and about 2% preferably between abut 0.05% and about 0.5% by weight based on the total weight of enzyme and protein at temperatures between about 4° C. and about 55° C., preferably between about 25° C. and about 40° C., for a time between about 5 mins and about 24 hrs., preferably between about 0.5 hrs. and about 2 hrs.

In accordance with this invention, the aqueous acidic protein solution or the concentrated aqueous acidic protein solution comprising myofibrillar proteins and sarcoplasmic proteins and/or aqueous acidic peptide solutions is applied to the surface of the uncooked, partially cooked or cooked food, or is mixed with the food such as hamburger, sliced reformulated beef or sausage or is injected into the food. The term “a surface” as used herein is a surface of the fish or meat which is positioned 90 degrees from an adjacent surface or surfaces of the meat or fish. In addition, the term “a surface” can comprise the connecting surface connecting two adjacent surfaces positioned 90 degrees from each other. Preferably, the entire surface of the food is coated with the protein solution and/or peptide solution. The coated food then can be cooked at elevated temperature.

It has been found in accordance with this invention that the addition of the aqueous acidic protein solution, concentrated aqueous acidic protein solution and/or aqueous acidic peptide solution of this invention to uncooked food provides an unexpected preservative effect in that it reduces degradation by microbes to the food. It is preferred that the aqueous acidic protein solution, concentrated aqueous acidic protein solution and/or aqueous acidic peptide solution be applied to the surface of the food in order to provide this preservation effect.

In one aspect of this invention, particulate food such as ground meat or fish, e.g. hamburger, is mixed with the aqueous acidic protein solution, concentrated aqueous acidic protein solution and/or aqueous acidic peptide solution at a weight ratio usually comprising about 0.03% to about 15% weight of the protein and/or peptide based on the weight of the food, preferably between about 0.5 and 5% weight based on the weight of food and most preferably comprising between about 0.5 to about 2% weight based on the weight of the food. When the concentrated aqueous acidic protein solution and/or aqueous acidic peptide solution is applied to at least one surface of the food or it is applied by injection, the amount of the protein solution and/or peptide solution added is the same weight ratio as set forth above when mixed with food. When utilizing less than about 0.03% weight aqueous acidic protein solution, concentrated aqueous acidic protein solution and/or aqueous acidic peptide solution, effective bacterial destruction is not observed. When utilizing greater than about 15 % aqueous acidic protein solution, concentrated aqueous acidic protein solution and/or aqueous acidic peptide solution, the cooked food can become undesirably gummy or particulated.

The food which is treated in accordance with this invention comprises vegetables, eggs, including whole eggs, poultry, meat and fish, including shell fish. Representative suitable fish include deboned flounder, sole, haddock, cod, sea bass, salmon, tuna, trout or the like. Representative suitable shell fish include shelled shrimp, crabmeat, crayfish, lobster, scallops, oysters, or shrimp in the shell or the like. Representative suitable meats include ham, beef, lamb, pork, venison, veal, buffalo or the like; poultry such as chicken, mechanically deboned poultry meat, turkey, duck, a game bird or goose or the like either in fillet form or in ground form such as hamburg. The meats can include the bone of the animal when the bone does not adversely affect the edibility of the meat such as spare ribs, lamb chops or pork chops. In addition, processed meat products which include animal muscle tissue such as a sausage composition, a hot dog composition, emulsified product or the like can be coated, injected or mixed with the aqueous acidic protein solution, aqueous acidic peptide solution, aqueous acidic protein solution, or a combination of these addition methods. Sausage and hot dog compositions include ground meat or fish, herbs such as sage, spices, sugar, pepper, salt and fillers such as dairy products as is well known in the art. When whole eggs are processed in accordance with this invention, the aqueous acidic protein solution, concentrated aqueous acidic protein solution and/or aqueous acidic peptide solution is applied to the outside shell surface.

The food containing the concentrated aqueous acidic protein solution or aqueous acidic protein solution and/or aqueous acidic peptide solution then can be cooked in a conventional manner such as by baking, broiling, deep fat frying, pan frying, in a microwave oven or the like.

While the invention described above relates to the destruction of bacteria or control of bacteria growth in food, it is evident that the aqueous acidic protein solution, concentrated aqueous acidic protein solution and/or aqueous acidic peptide solution can be utilized to destroy bacteria and/or control bacterial growth in other environments. For example, these protein and/or peptide solutions can be utilized to destroy bacteria or control bacterial growth in the human body. These protein and/or peptide solutions can be applied to or implanted into the human body to destroy unwanted bacteria in the human body such as streptococcus or staphylococcus bacteria. The aqueous acidic protein solution, concentrated aqueous acidic protein solution and/or aqueous acidic peptide solution can be applied directly to the human body such as to an open wound such as by spraying or applied to the human body either directly alone or on a physiologically acceptable substrate such as a bandage or a physiologically acceptable biodegradable polymer composition. The acidic characteristics of the aqueous acidic protein solution, concentrated aqueous acidic protein solution and/or aqueous acidic peptide solution function to destroy or control growth of bacteria. The protein and/or peptide in these solutions function to provide nutrient growth factors to support growth of new tissue. The biodegradable polymer, when used, functions to position the acidic components and the nutrient growth components in the desired portion of the body when implanted or applied to the body. The biodegradable polymer composition then slowly degrades to be metabolized by the body and excreted, leaving the nutrient growth factors and tissue products which utilized the nutrient growth factors as well as the acidic factors that destroy or control growth of bacteria. This process of destroying or controlling growth of bacteria in or on the body has the advantage of avoiding the use of antibiotics which have undesirable side effects, well known, in the art, including the formation of antibiotic resistant bacteria that are difficult to control. Representative suitable biodegradable polymers are disclosed in U.S. Pat. Nos. 4,881,225; 4,906,474; 5,122,367; 5,618,563; 5,902,599; 3,297,033; 3,739,773; 6,214,285; 6,160,084; 3,839,297 and 5,399,665, all of which are incorporated herein in their entirety by reference. Other representative suitable environments in which the aqueous acidic protein solution, concentrated aqueous acidic protein solution, and/or aqueous acidic peptide solution can be utilized to destroy or to control bacterial growth include food processing apparatus, food processing or medical (hospital) processing environments, (spraying into atmosphere or application to exposed surfaces). In addition, the aqueous acidic protein solution, concentrated aqueous acidic protein solution and/or aqueous acidic peptide solution can be utilized as a coating on gas filters, e.g., air filters such as bulk filters formed from fibers, e.g. polyethylene or polypropylene fibers to destroy or control bacteria in a gas.

The following examples illustrate the present invention and are not intended to limit the same.

### EXAMPLE 1

### Ultrafiltration of Myofibrillar & Sarcoplasmic Pork Proteins and Bacteria Control in Pork

Fresh pork loin muscle was ground to approximately ⅛^{th} inch and placed into a 5000 ml plastic beaker containing 900 ml cold filtered water (Millipore-Milli DI). The muscle-water mixture was homogenized using a PowerGen 700 homogenizer (Fisher Scientific) on speed 6 for 2 minute. The homogenate was adjusted to pH 2.8 using 2 N hydrochloric acid added drop-wise. The acidified homogenate was centrifuged at 11,000 times gravity force in a Sorvall RC-5B refrigerated centrifuge in a GS-30 rotor for 30 minutes. The protein layer was filtered through four layers of cheesecloth. A 500 ml aliquot was placed into a Millipore Labscale TFF system equipped with a Pellicon XL, PXB050A50, 50,000 Daltons NWCO, polyethersulfone ultrafiltration cassette. The unit was run in a concentration mode using a feed pressure of 30 psi and a retentate pressure of 10 psi. The starting material was 1.7 Brix % and had a protein concentration of 18.11 mg/ml. After approximately 12 hours the retentate material was 5.6 Brix % and had a protein concentration of 44.80 mg/ml. The starting material had a moisture content of 98.4% and a cholesterol value of 2.34 mg/100 g. The retentate had a moisture content of 94.9% and no cholesterol was detected. The methods used were AOAC 15^{th} edition 1995. Approximately 20 ml of the retentate was placed in a small plastic dish and microwaved for 30 seconds and cooled. The resultant material was a soft gel with no residual or loose water.

The concentrated aqueous acidic protein solution was added to fresh, case-ready, pork chops (sell-by-date was the next day) were selected and divided into two groups, treated and controls. The controls were placed into plastic, Ziploc®g containers and placed into a refrigerator at 34° F. The treated samples were fully dipped into the above described (5.6 Brix %) retentate and shaken to remove excess protein solution. The treated samples were placed with the controls in refrigerated storage in plastic, Ziploc® containers. All samples were inspected visually, and for odor development every day for a period of 10 days. The controls lasted 2-3 days and the treated samples lasted 9-10 days before the development of off odors.

### EXAMPLE 2

Object

This example was conducted to determine the number of viable microorganisms present in chicken protein when inoculated with Salmonella and Listeria Species microorganisms held under controlled refrigerated storage conditions.

Sample Identification

Two chicken protein solutions were produced by comminuting chicken muscle tissue and then mixing the comminuted tissue with phosphoric acid. The solutions were filtered to remove solid particles. One chicken protein solution produced had a pH of 2.0. The second protein chicken solution has a pH of 3.0.
1. Chicken Protein Solution—pH=2.00 (2.5% Brix %)
2. Chicken Protein Solution—pH=3.00 (2.5% Brix %)
   Methodology

A four (4) 200 ml sample of each chicken protein solution was inoculated with cultures of the following microorganisms.
1. Salmonella Choleraesuis ATCC #13311
1. Listeria monocytogenes ATCC #19115

A suitable concentration of the test organism was added to each chicken protein solution and mixed well so that the concentration in the test preparation immediately after inoculation was between 1,200,000-1,300,000 microorganisms per ml.

The number of viable microorganisms in each inoculum suspension was determined and calculated from the initial concentration of microorganisms per ml of product under test by the plate-count method.

The inoculated chicken protein solution samples were stored under controlled refrigerated storage conditions at 38° F. and at 0-time, 1 day, 2 days, 3 days, 4 days, 5 days, 6 days and 7 day intervals, the products were evaluated for their microbiological makeup to determine the number of viable microorganisms present at each of the time intervals. In addition uninoculated chicken protein solution samples (controls) were tested initially.

Results:

TABLE 1

| | |
|---|---|
| PRODUCT IDENTIFICATION | 3. Day-2 |
| CHICKEN PROTEIN-pH + 3.00 | 4. Day 3 |
| Time After Inoculation | SALMONELLA |
| 1. 0 TIME | CHOLERAESUIS ATCC #13311 |
| 2. Day-1 | COUNT/ML (CFU) |
| 700,000 | Time After Inoculation |
| 0 | 1. 0-TIME |
| 0 | 2. Day-1 |
| 0 | 3. Day-2 |
| 5. Day 4 | 0 |
| 6. Day 5 | 0 |
| 7. Day 6 | 0 |
| 8. Day 7 | 0 |
| Control-(Uninoculated) | Aerobic Plate Count/ml 0 |

TABLE 2

| PRODUCT IDENTIFICATION | SALMONELLA |
|---|---|
| CHICKEN PROTEIN-pH + 2.00 | CHOLERAESUIS ATCC #13311 |
| Time After Inoculation | COUNT/ML (CFU) |
| 1. 0-TIME | 310,000 |
| 2. Day-1 | 0 |
| 3. Day-2 | 0 |
| 4. Day-3 | 0 |
| 5. Day-4 | 0 |
| 6. Day-5 | 0 |
| 7. Day 6 | 0 |
| 8. Day 7 | 0 |
| Control-(Uninoculated) | Aerobic Plate Count.ml 0 |

TABLE 3

| | |
|---|---|
| PRODUCT IDENTIFICATION | LISTERIA MONOCYTOGENES |
| CHICKEN PROTEIN-pH = 2.00 | ATCC #19115 |
| COUNT/ML (CFU) | |
| 950,000 | |
| 0 | |
| 0 | |
| 4. Day-3 | 0 |
| 5. Day-4 | 0 |
| 6. Day-5 | 0 |
| 7. Day-6 | 0 |
| 8 Day-7 | 0 |
| Control-(Uninoculated) | Aerobic Plate Count.ml 0 |

TABLE 4

| PRODUCT IDENTIFICATION | |
|---|---|
| CHICKEN PROTEIN-pH = 3.00 | LISTERIA MONOCYTOGENES |
| Time After Inoculation | COUNT/ML (CFU) |
| 1. 0-TIME | 1,100.000 |
| 2. Day-1 | 520,000 |
| 3. Day-2 | 480,000 |
| 4. Day-3 | 400,000 |
| 5. Day-4 | 140,000 |
| 6. Day-5 | 130,000 |
| 7. Day 6 | 110,000 |
| 8. Day 7 | 66,000 |

Discussion:

Chicken Protein pH 2.00 would not support growth or proliferation of inadvertent contaminating microflora or of Salmonella & Listeria deliberately added to the Chicken protein solution for up to 7 days of incubation at refrigerated temperature. The Chicken Protein solution (pH 3.00) does not support the growth of Salmonella microorganisms. The Chicken Protein solution pH 3.00 does not support the growth of Listeria, however there is a significant reduction of Listeria microorganisms throughout the test period. This study indicates that the unfavorable pH is responsible for the inability of the chicken protein to support the Salmonella & Listeria inoculated microflora for periods up to seven (7) days at refrigerated temperature.

1. The process for destroying or controlling growth of a bacteria on a substrate which comprises contacting said substrate with an acidic composition selected from the group consisting of an aqueous acidic protein solution isolated from animal muscle tissue having a pH of about 3.5 or less, an aqueous acid peptide solution derived from protein isolated from animal muscle tissue and having a pH of about 3.5 or less and mixtures thereof for a time sufficient to effect destruction or growth control of said bacteria.

2. The process of claim 1 wherein the acidic composition is a concentrated aqueous acidic protein solution derived from animal muscle tissue.

3. The process of claim 1 wherein the substrate is a food.

4. The process of claim 2 wherein the substrate is a food.

5. The process of claim 3 wherein said food is poultry.

6. The process of claim 3 wherein said food is meat.

7. The process of claim 3 wherein said food is fish.

8. The process of claim 3 wherein said food is whole eggs.

9. The process of claim 4 wherein said food is poultry.

10. The process of claim 4 wherein said food is meat.

11. The process of claim 4 wherein said food is fish.

12. The process of claim 4 wherein said food is whole eggs.

13. The process of any one of claims 1, 2 or 3 wherein the acidic composition is applied to at least one surface of said substrate.

14. The process of any one of claims 1, 2 or 3 wherein the acidic composition is applied to all surfaces of said substrate.

15. The process of any one of claims 1, 2 or 3 wherein the acidic composition is mixed with said substrate.

16. The process of any one of claims 1, 2 or 3 wherein the protein composition and/or peptide composition is injected into said substrate.

17. The process of any one of claims 1, 2 or 3 wherein the protein composition and/or peptide composition is injected into said substrate and is applied to all surfaces of said substrate.

18. The process of any one of claims 1, 2 or 3 wherein said protein composition and/or said peptide composition is mixed with said substrate and is applied to all surfaces of said substrate.
